(19) United States
(12) Patent Application Publication
(10) Pub. No.: US 2001/0020325 A1
(43) Pub. Date: Sep. 13, 2001

(54) Apparatus for placing components on circuit bases

(75) Inventor: Hans-Werner Lueckehe, Salzkotten (DE)

Correspondence Address: BAKER & BOTTS, 30 ROCKEFELLER PLAZA, NEW YORK, NY, 10112

(73) Assignee: Siemens Aktiengesellschaft.

(21) Appl. No.: 09/809,977

(22) Filed: Mar. 16, 2001

Related U.S. Application Data
(63) Continuation of application No. PCT/DE99/02676, filed on Sep. 18, 1998.

(30) Foreign Application Priority Data
Sep. 18, 1998 (DE) 19842951.7

(51) Int. Cl. B23P 19/00

(52) U.S. Cl. 29/740; 29/771

(57) ABSTRACT

An apparatus for placing electrical components on a circuit board, having a placement unit and a feed unit for feeding the components thereto. The feed unit contains a magazine with an associated identification medium and a monitoring unit. Component-related data is stored in the identification medium. The monitoring unit is used to compare the component-related data with placement-related data which are predetermined by a central data processing unit to effect an accurate match between the two.

### BACKGROUND OF THE INVENTION

The invention relates to an apparatus for placing a number of electrical components, in particular surface mounted components (a/k/a surface mounted devices or SMDs), on circuit boards or bases, having a placement unit for placing the components on the circuit board and a feed unit for feeding the components, which are provided in a magazine.

In order to place electrical components on circuit boards, the components are normally provided in magazines and are fed to a placement unit by means of a feed unit. In order to ensure fault-free and continuous feeding to the placement unit, the electrical components can be provided on belts in the form of strips, which can be unwound from a roll. In order to allow a high throughput rate, one placement unit has a number of associated feed units and magazines. In order to identify the correct association between a magazine and a corresponding feed unit when equipping or replenishing the placement unit, the magazine is usually provided with a barcode tag which contains the component-related data. This data is read by means of a barcode reader in a data processing unit, and is then compared with certain predetermined nominal data. While this method admittedly enables accurate identification of the type of components provided in a particular magazine, it does not eliminate the possibility of a magazine from being assigned to the wrong feed unit.

### SUMMARY OF INVENTION

The object of the present invention is thus to provide an apparatus for placing electronic components on circuit boards, in such a manner that incorrect placement is reliably avoided.

In order to achieve this object, each magazine has an associated identification medium and each feed unit has an associated monitoring unit. Component-related data is stored in the identification medium and the monitoring unit is used to compare the component-related data for the magazine with placement-related data which are predetermined by a central data processing unit, so that the component-related data is matched with the placement-related data. In this way, the correct magazine is provided to the appropriate feed unit to place the components in the appropriate placement unit.

A particular advantage of the present invention is that the identification medium for the magazine can be used more than once. After completion of the placement process, the identification medium can be removed from the magazine and can be assigned to a another magazine, which has not yet been loaded. Accordingly, the invention enables the checking of correct assignment of the magazine directly at the point where the components are fed to the placement unit and uniquely avoids incorrect placement. In accordance with the apparatus and process, the component-related data stored in the identification medium can be checked to ensure that they match predetermined placement-related data in a monitoring unit. If a match is found, a signal may be emitted and the components in the corresponding magazine can be placed on the circuit board. Local and automatic checking thus reliably avoids any incorrect placement resulting from incorrect assignment of a magazine to a feed unit.

According to one embodiment of the present invention, the identification medium is detachably connected to the magazine so that it can be reused, i.e., used for other magazines once the first magazine has been emptied. Alternatively, the identification medium may be connected in a fixed manner to the magazine, thus preventing it from being detached or removed from the magazine when this is not desired.

Each feed unit of the present invention has an associated monitoring unit, with the identification medium being configured in such a manner that it can be engaged with the monitoring unit in the placement position. This makes it possible to ensure that correct assignment of the magazine can be checked automatically when the components are being loaded in the magazine.

According to a further embodiment of the present invention, the identification medium is formed in such a way that the magazine can be moved to the intended placement position only when the identification medium has engaged with the monitoring unit. For this purpose, the identification medium has a desired shape, e.g., angle-shape, in which case a first end can be mechanically coupled to the magazine and a second end can be mechanically and electrically coupled to the monitoring unit. In this circumstance, the second end has coupling elements which interact with a write/read unit in the monitoring unit. As a refinement of this embodiment, the second end of the identification medium may be formed with contact surfaces on one face, in order to make contact with correspondingly arranged contacts on the write/read unit. The component-related data are stored in an integrated circuit (chip) in the identification medium. The chip is preferably arranged inside the identification medium, so that it is protected against damage.

Further advantages of the invention will be apparent from the drawings and detailed description of the present invention.

### DESCRIPTION OF THE DRAWINGS

FIG. 1 is a perspective view of a changeover table which is provided with a number of magazines, and feed units associated with the respective magazines, for a downstream placement unit.

FIG. 2 illustrates a magazine with an identification medium, in which component-related data can be read.

### DETAILED DESCRIPTION OF THE INVENTION

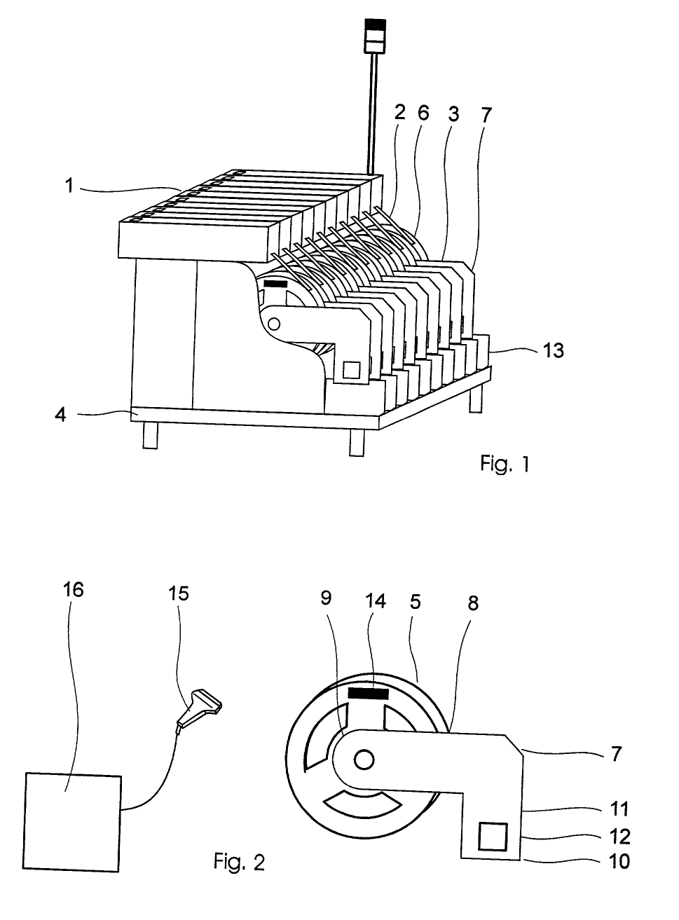

With reference to FIG. 1, the apparatus according to the present invention provides for the accurate placement of electronic components on circuit boards and comprises a placement unit (not shown in FIG. 1), and a number of feed units 1. Electrical components 2, in particular SMD components, are fed to the placement unit via feed unit 1 and are positioned at a predetermined point on a circuit board (now shown). Once the SMD components 2 have been fixed on the circuit board by means of a solder paste, they can be finally secured on to it, for example, by using a reflow soldering method with an electrically conductive connection being produced to the conductor tracks provided on the circuit board.

In order to place the SMD components 2 on the circuit board automatically, the components 2 are provided in magazines 3, which each have an associated feed unit 1. In order to ensure as high a throughput rate as possible, a number of magazines 3 are placed on a changeover table 4 which is positioned in a feed area of the placement unit in such a manner that the magazines 3 are each arranged such that they are flush with the feed unit 1, which is in the form of a feed chute.

With reference to both FIGS. 1 and 2, the magazines 3 each comprise a roll 5, on which a flexible belt 6 in the form of a strip is wound. The SMD components 2 are located at regular intervals on the belt 6. The magazines 3, or the roll 5, is connected to an identification medium 7, which is essentially composed of a flat plastic material. A first end 8 of the identification medium 7 is detachably connected on the rotation axis of the roll 5 by means of a fastening element 9. A second end 10 of the identification medium 7 has a chip which is embedded in a cutout in the plastic material and is electrically connected to contact surfaces 12 which run flush with an upper face 11 of the identification medium 7. Both the configuration of the second end 10 and the arrangement of the contact surfaces 12 comply with the standards for a smart card. This allows the second end 10 to be inserted into a conventional write/read unit 13 for smart cards.

In the present embodiment, every second end 10 of a magazine 3 has an associated write/read unit 13. The write/read units 13 are arranged in the form of a row and alongside one another. The write/read unit 13 forms a monitoring unit which, firstly, has a contact-making unit for mechanical and electrical coupling of the second end 10 and, secondly, has a control unit with a microprocessor.

In utilizing the foregoing apparatus in the context of a setting-up process, the component-related data, which are stored as a barcode 14 on a respective roll 5, are read to a central data processing unit 16 by means of a hand-held scanner 15. The data processing unit 16 may be in the form of a setting-up location computer and may be associated with a number of placement units. The data processing unit 16 has all the data relevant for the setting-up process, such as the type of placement unit, the arrangement of the feed units on specific sides of the placement unit, etc. These form the set-up-related data, which are required to associate the magazine 3 with the correct respective feed units 1. The component-related data are then written from the central data processing unit 16 to the chip of the identification medium 7 by means of a write/read unit, which is not illustrated. The chip in the identification medium 7 is preferably in the form of a memory chip with a nonvolatile memory (EEPROM). When the chip is being written to, the identification medium 7 will already have been connected mechanically and in a captive manner to the roll 5, which is fitted with the corresponding components 2. This ensures that the component-related data, which are in the form of a barcode on the relevant magazine, namely the type of component 2, are identical to the component-related data read to the chip.

In order to set up the apparatus, the operator uses the central data processing unit 16 to select the desired fit, and transmits the selected set-up-related data to the respective write/read units 13, which are arranged on the changeover table 4. The set-up-related data form the nominal data for the respective magazine 3 which will later be mounted on the changeover table 4.

In a further step, the magazines 3 are associated with the respective feed unit 1 in accordance with the requirement from the central data processing unit 16, and are positioned in the corresponding compartment on the changeover table 4. For correct positioning, the second end 10 must be inserted into the write/read unit 13 intended for it. Once electrical contact has been made with the chip in the identification medium 7 in the write/read unit 13, the component-related data are read from the chip in the identification medium 7 to a memory in the write/read unit 13. The microprocessor in the write/read unit 13 has an associated program, which allows the component-related data to be compared with the placement-related data stored in the corresponding write/read unit 13. If the component-related data matches the placement-related nominal data, an enable signal is produced which signals to the operator that the magazine 3 is located in the intended chute of the changeover table 4, and is associated with the intended feed unit 1. This comparison is carried out successively for each magazine 3.

Since the magazine 3 is not arranged in the correct position for the feed process until the second end 10 of the identification medium 7 has been inserted in the write/read unit 13, a check, as described above, of correct feeding is a condition for starting up the placement unit. This reliably makes it possible to avoid incorrect placement owing to non-placement.

Alternatively, the second end 10 can also be configured with contact surfaces arranged on one end face in the same way in form of a row, which can be positioned with respect to corresponding contact elements on a write/read unit. Alternatively, the comparison can also be carried out in the central data processing unit 16, provided the write/read units 13 are connected to it by means of electrical conductors. Accordingly, the apparatus of the present invention utilizes the identification medium 7 together with the stored component-related data connected to the respective magazine 3, preferably in a fixed manner. In this way, the mobile write/read units can check the component-related data at any time and independent of location. The placement of components 2 in magazines on a changeover table 4 is preferably enabled once a match between the component-related data and the nominal data has been found for all the magazines 3 on the changeover table 4.

1. An apparatus for placing electrical components on a circuit board comprising a placement unit, at least one feed unit having a monitoring device and at least one magazine having an identification medium in which component-related data is stored, wherein the monitoring device compares the component-related data with predetermined placement-related data to insure the two match and that the desired components are accurately fed to the placement unit.

2. The apparatus according to claim 1 wherein the electrical components are surface mounted components.

3. The apparatus according to claim 1 wherein the identification medium is detachably connected to the magazine.

4. The apparatus according to claim 1 wherein the identification medium is compatible with smart card standards.

5. The apparatus according claim 1 wherein the feed unit and the identification medium are engaged in the placement unit.

6. The apparatus according to claim 1 wherein the monitoring device is in the form of a write/read unit which is electrically connected to a central processing unit.

7. The apparatus according to claim 1 wherein the magazine contains component-related data in barcode form which can be read by a scanner for storage of the data in a central processing unit.

8. The apparatus according to claim 1 wherein the identification medium is flat, having a first end which can be mechanically coupled to the magazine and a second end that can be mechanically and electrically coupled to the monitoring device.

9. The apparatus according to claim 8 wherein the second end of the flat identification medium is in the form of a card having contact surfaces arranged on a surface of the card for making contact with corresponding contacts on the write/read unit.

10. The apparatus according to claim 8 wherein the second end of the flat identification medium has a memory chip in which component-related data are stored.

11. The apparatus according to claim 1 wherein the magazine is in the form of a belt which contains a plurality of components and wherein the belt is wound on a roll.
